(19) United States
(12) Patent Application Publication
(10) Pub. No.: US 2009/0260579 A1
(43) Pub. Date: Oct. 22, 2009

(54) LOW PROFILE CAGE WITH REFUSE CATCHER

(76) Inventors: Alan Cohen, Laurel Hollow, NY (US); Vincent Senese, Manorville, NY (US)

Correspondence Address: RIVKIN RADLER LLP, 926 RexCorp Plaza, UNIONDALE, NY, 11556-0926, US

(21) Appl. No.: 12/363,726

(22) Filed: Jan. 31, 2009

Related U.S. Application Data
(60) Provisional application No. 61/063,270, filed on Feb. 1, 2008.

(51) Int. Cl. A01K 31/06; A01K 1/01

(52) U.S. Cl. 119/469; 119/479

(57) ABSTRACT

A cage for small animals includes a generally closed base having an open top; a grating structure upon the base forming a closed structure for containing an animal therein; and a refuse catcher surrounding the grating structure and removably fastened to the base so as to permit the refuse catcher to be removed from the base by being detached from the base and moved upward away from the base without removing the grating structure from the base. The cage can be a bird cage, wherein the refuse catcher is a seed catcher that is formed of a plurality of mating parts, the parts being releasable attached to each other and to the base.

This application claim priority under 35 U.S.C. §119(e) from provisional patent application Ser. No. 61/063,270 filed on Feb. 1, 2008, which is incorporated by reference herein, in its entirety, for all purposes.

### BACKGROUND OF THE INVENTION

1. Field of the Invention

The present invention relates to animal cages. More particularly, and although not so limited, it relates to cages for small animals and to birdcages, and is especially useful for birds kept as a pet in a home environment.

2. Background Art

While various small animals, and as an example, birds (not by way of limitation) or parakeets, make excellent pets, they require a good deal of maintenance and support. Small animals such as hamsters or gerbils require a bedding material, portions of which are often ejected from the cage. Generally, one problem associated with small birds in captivity is that the food that they eat generally contains seeds. The birds, when feeding, crack open the seeds and eat the interior portion. Birds generally eject the uneaten portion or shell from their cage. These ejected seed shells and other waste can cause a mess around the cage, which needs to be cleaned up on a rather frequent basis.

There have been a variety of ways to deal with this situation. Various prior art bird cages have built in seed catcher structures about the periphery to catch the shells of seeds and other waste products that are ejected from the cage. Sloping surfaces, and appropriate openings in the cage aligned with the bottom of the seed catcher, return such ejected waste material to the cage, where the material falls to the cage bottom. Provisions are made in the base of the cage, such as a removable tray, under a grill, to make it possible to remove the waste material from the cage.

Another seed guard or catcher is in the form of clear polyethylene extruded plastic strips wrapped around the perimeter of the cage, and permanently affixed thereto.

Referring to FIG. 1 a prior art birdcage 20, without a seed catcher, is illustrated. The cage wall and top structure 22, formed of a metal grating, which can be disassembled and/or collapsed for shipping, has protrusions around its periphery, generally in the form of loops 23 which fit into opening in the birdcage base 24 to secure wall and top structure 22 to base 24 (formed of a polymer material) by flexing the wall of structure 22 just enough so that the loop protrusions 23 may be placed in the openings in the base. A grating (not shown) is placed at the top of the base prior to assembly. The bottom of the base 24 receives a sliding tray 26, which is removed to empty waste.

One problem associated with this approach is that the base 24 of the cage begins to be rather tall, resulting in added height to the birdcage, and an appearance that some may find to be not esthetically pleasing. Further, this increased height is a limitation on the smallest thickness possible for a package containing the birdcage components in disassembled form, thus increasing storage and shipping cost.

Another problem associated with prior art bird cages with surrounding seed catchers is that of what happens when birds are temporarily allowed out of their cages (for example in a house or apartment). A bird will tend to perch at the highest part of the top of the cage. However, the tail of the bird will become uncomfortable if the bird is facing outward, as the tail then contacts the cage, causing pressure and the resulting discomfort. Thus, the bird will often perch at the edge of the top of the cage, facing toward the cage center, so that the tail is off in space next to the cage and does not rest on the cage top. The unfortunate result of this position is that bird droppings tend to fall directly on any surrounding seed catcher, which generally extends outward form the cage. The bird droppings, and waste material ejected from the cage, tend to dirty the seed catcher, requiring that it be periodically cleaned. However, this is a relatively time consuming, difficult and unpleasant task, because in these prior art structures, the seed catchers often are not easily or not at all removable from the cage. A better approach is required.

### SUMMARY OF THE INVENTION

It is an object of the invention to provide an animal cage having a base of low profile, which is esthetically pleasing and may be shipped, together with other components of the cage, in a relatively thin package.

It is a further object of the invention to provide a refuse catcher structure that may readily be removed from the cage, in order to facilitate cleaning of the refuse catcher.

It is another object of the invention to provide a structure for an animal cage with a refuse catcher that may be readily assembled from its component parts without the use any tools.

These objects and others are achieved in accordance with the invention by providing an animal cage comprising a generally closed base having an open top; a grating structure upon the base forming a closed structure for contain an animal therein; and a refuse catcher, or seed catcher in the case of a birdcage, surrounding the grating structure and removeably fastened to the base so as to permit the refuse catcher to be removed from the base by being detached from the base and moved upward away from the base without removing the grating structure from the base.

The refuse or seed catcher is formed of a plurality of mating parts, the parts being releasably attached to each other and to the base. The plurality of parts may be released from each other so that a single part may be released from the base.

The base can be of generally rectangular shape or configuration, but may be in the shape of any polygon, or even circular in configuration. The refuse catcher can be formed of parts, with each part corresponding to a side of the base, and the base can be configured with openings to accept a projection from each of the parts so as to removeably connect the parts to the base.

Two of the parts can be sized and shaped to follow a corner of the base and to be in contact with two sides of the base, and two of the parts can be configured to each contact only a single side of the base.

The base can have a rim at its top, the rim defining a narrow ledge for receiving a bottom edge of the parts of the seed catcher.

A plurality of the parts can include a projection for fitting into a first opening of an adjacent one of the parts. The projection may be formed in a generally rectangular shape. The first projection can be formed of a polymer, and the first opening can be sized and shaped to receive the projection.

A plurality of the parts can include a second projection for fitting into a second opening of an adjacent one of the parts. The second projection can be formed generally in the shape of a solid rectangle.

The base is preferably formed of a polymer. The refuse or seed catcher is preferable formed of a polymer of a type that is easily cleaned of debris. The polymer may be formed of polystyrene or polypropylene. The refuse or seed catcher is shaped so as to curve away from said base.

### BRIEF DESCRIPTION OF THE DRAWINGS

The foregoing aspects and other features of the present invention are explained in the following description, taken in connection with the accompanying drawings, wherein:

FIG. 1 is a front perspective view of a prior art bird cage.

FIG. 2 is a front perspective view of a bird cage in accordance with the invention.

FIG. 3 is a perspective view of the base of the bird cage of FIG. 2, with the components of a removable seed catcher in place.

FIG. 4 is an enlarged perspective view of a corner of the base of the birdcage of FIG. 3.

FIG. 5 is an enlarged side elevational view of the left side component of the seed catcher illustrated in FIG. 4.

FIG. 6A is an enlarged front elevational view of the left side component of the seed catcher illustrated in FIG. 4.

FIG. 6B is an enlarged front elevational view of the rear component of the seed catcher illustrated in FIG. 4.

FIG. 7 is a perspective view of the apparatus of FIG. 3, with a front component of the seed catcher removed.

FIG. 8 is an enlarged perspective view including the cage base and the right end of the removed front component of the seed catcher in accordance with the invention, as it is being removed or replaced.

FIG. 9 is an enlarged perspective view including the cage base and the left end of the removed front component of the seed catcher in accordance with the invention, as it is being removed or replaced.

### DETAILED DESCRIPTION OF THE PREFERRED EMBODIMENT

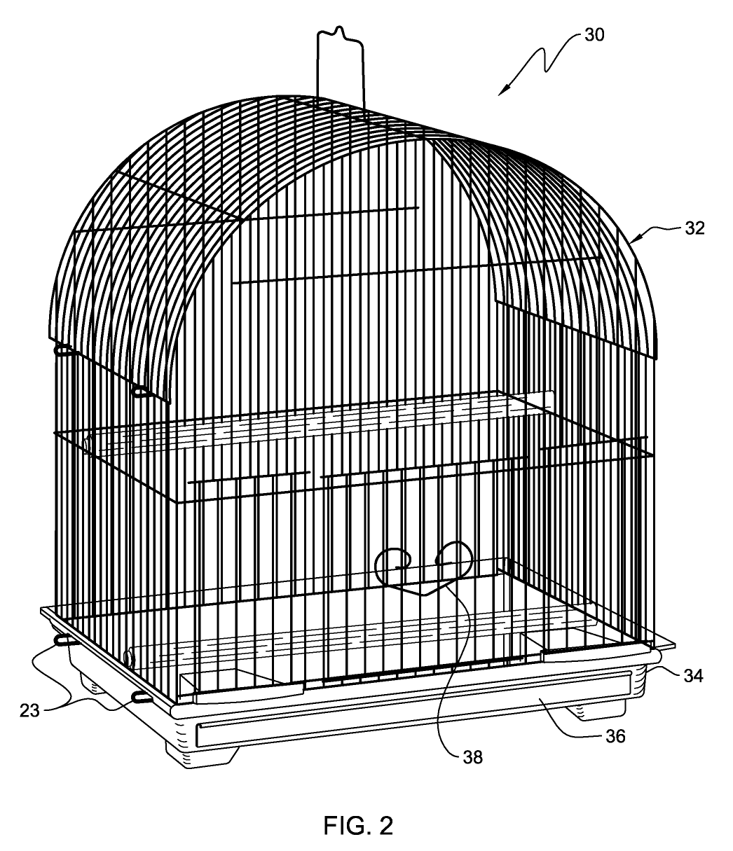

Referring to FIG. 2, a birdcage 30 in accordance with the invention, but with the seed catcher removed, is shown. Although the present invention will be described with reference to the single embodiment shown in the drawings, it should be understood that the present invention can be embodied in many alternate forms of embodiments. In addition, any suitable size, shape or type of elements or materials could be used.

Birdcage 30, has a cage wall and top structure 32, formed of a metal grating, which can be disassembled and/or collapsed for shipping, has protrusions around its periphery, generally in the form of loops 23 which fit into opening in the birdcage base 34 to secure wall and top structure 32 to base 34 (formed of a polymer) by flexing the wall of the top structure 32 just enough so that the loops 23 may be placed in the openings in the base. Alternatively, forks-like members (not shown) that protrude from base 34 may lock onto the cage wires of top structure 32. Other suitable arrangements may be made for securing top structure 32 to base 34. A grating (not shown) is placed at the top of the base 34 prior to assembly. The bottom of the base 34 receives a sliding tray 36, which is removed to empty waste. A suitable cage door 38, as is well known in the art, is provided.

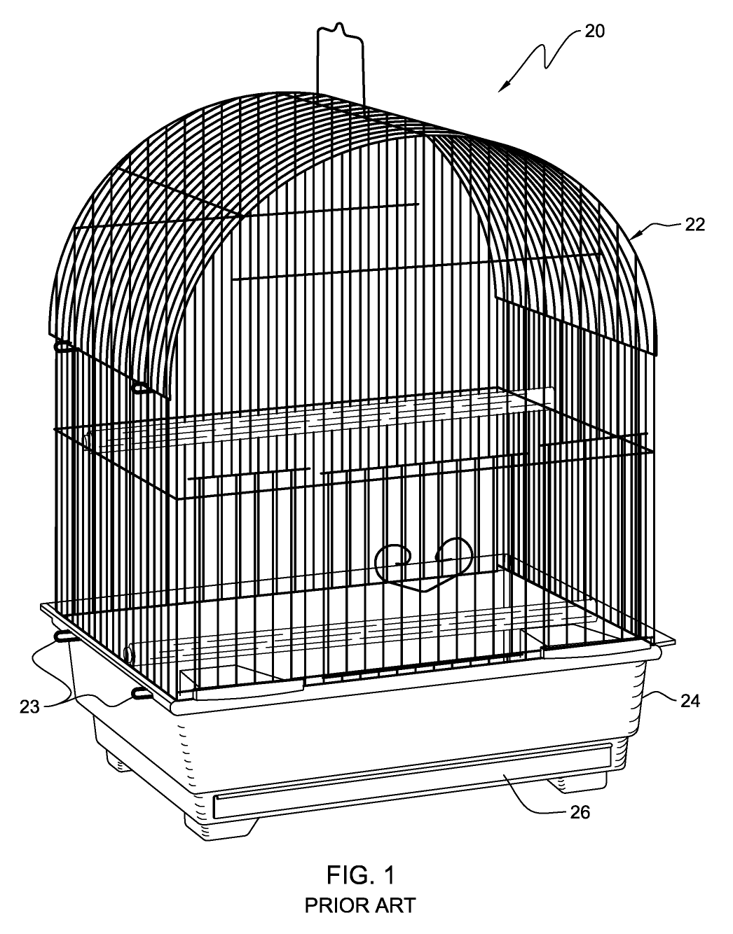

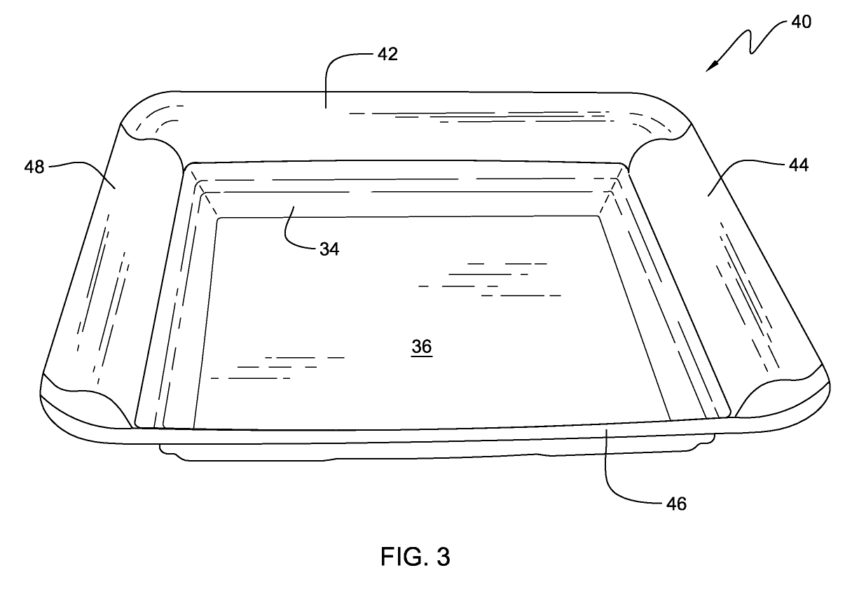

It is noted that in accordance with one aspect of the invention, base 34 (FIG. 3) is approximately less than half of the height of base 24 of prior art birdcage 20 (FIG. 1). While base 34 must be high enough to receive sliding tray 36, its very low profile is esthetically pleasing, and permits the various components of birdcage 30 to be shipped in much thinner package, thus saving on shipping and storage costs.

FIG. 3 illustrates base 34 of a birdcage in accordance with the invention, with the components of refuse catcher, and in particular, a seed catcher, shown generally as 40, in place. Seed catcher 40 includes a back member 42, a right side member 44, a front member 46, and a left side member 48, it being understood that the designations front, back, right and left are arbitrary, and are merely for ease of description herein.

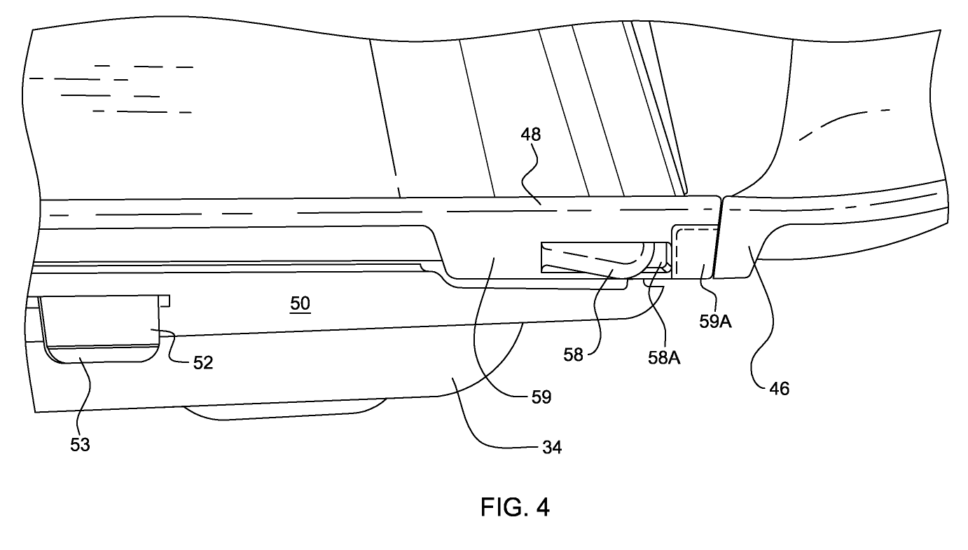

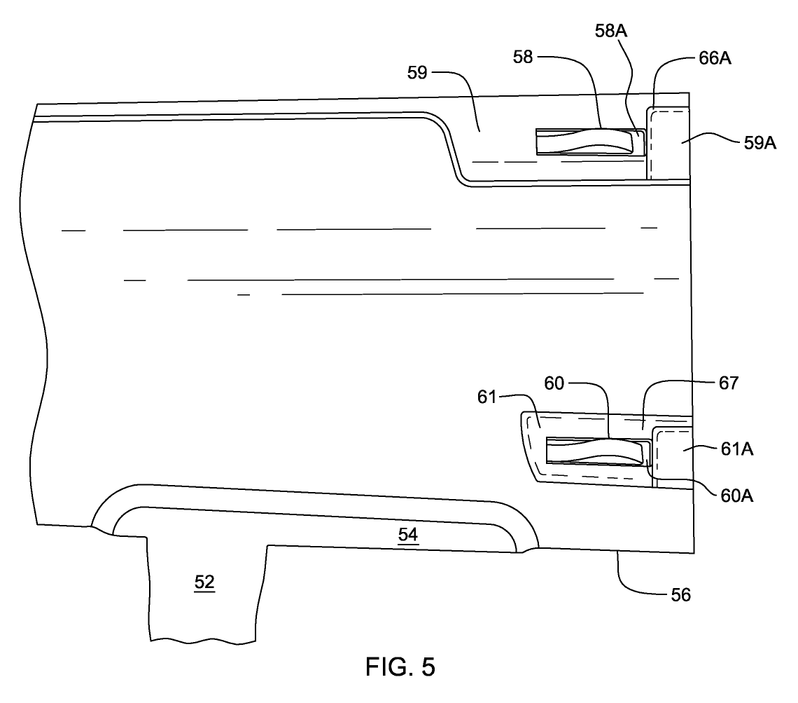

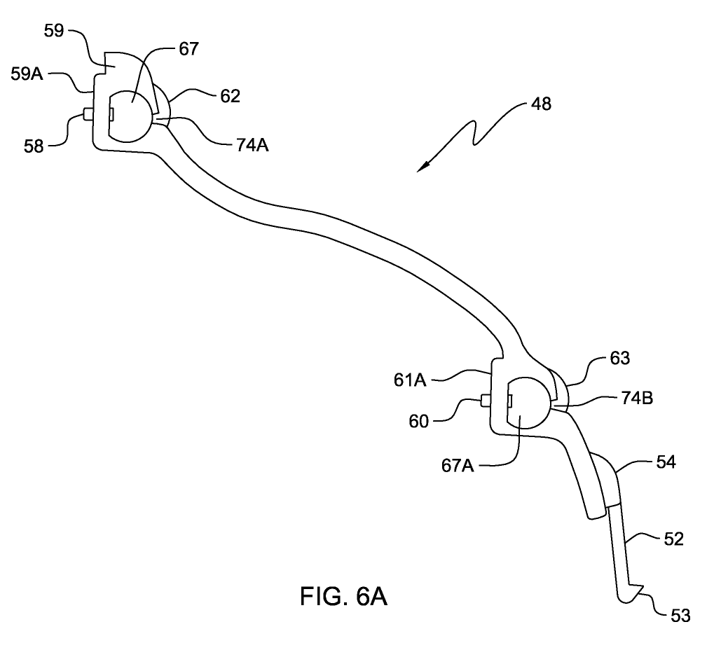

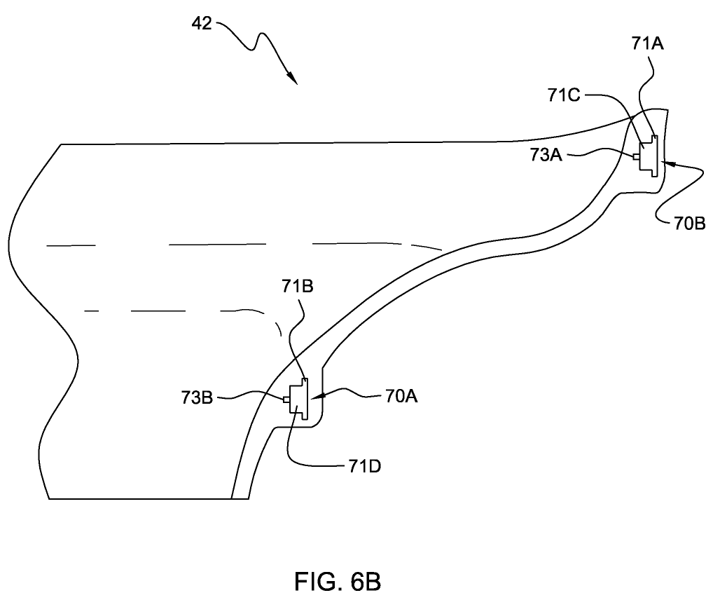

FIG. 4, together with FIG. 5, FIG. 6A and FIG. 6B, illustrate the manner in which left side member 48 is secured to base 34 and front member 46 is secured to left side member 48.

Base 34 has a pair of outwardly protruding pockets 50 for receiving corresponding downwardly extending locking protrusions 52 (only one shown in FIG. 4 and FIG. 5) of left side member 48, thus removeably locking left side member 48 to base 34. Protrusions 52 each have hooked ends 53 and each extend from an inwardly disposed portion 54 of the lower edge 56 of left side member 48, thus assuring that protrusions 52 are lined up with most of the length of the lower edge 56. Right side member 44 may be removeably attached to base 34 in the same manner.

FIG. 4, FIG. 5, FIG. 6A and FIG. 6B also illustrate, at the front end of left side member 48, an upper locking tab 58 and a lower locking tab 60. Tabs 58 and 60 are cantilevered projections which cover most of respective openings 58A and 60A, respectively, in respective external bosses 59 and 61 defined in left side member 48. External bosses 59 and 61 each have a respective sub-boss, 59A and 61A. At each end of left side member 48 and right side member 44, boss 59, sub-boss 59A, and an internal boss 62 (FIG. 6A) define an upper chamber 67. At each end of left side member 48 and right side member 44, boss 61, sub-boss 61A and an internal boss 63 define a lower chamber 67A. Upper locking tab 58 may barely protrude into upper chamber 67. Lower locking tab 60 may barely protrude into lower chamber 67A.

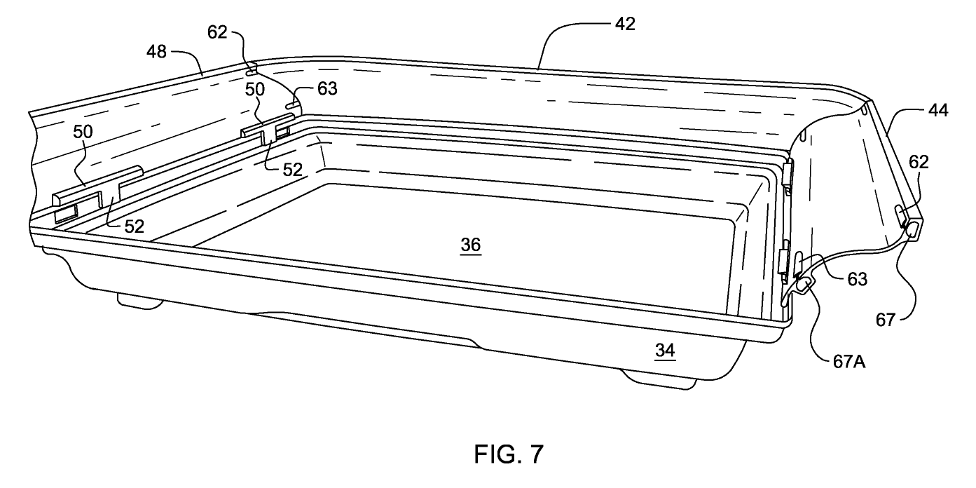

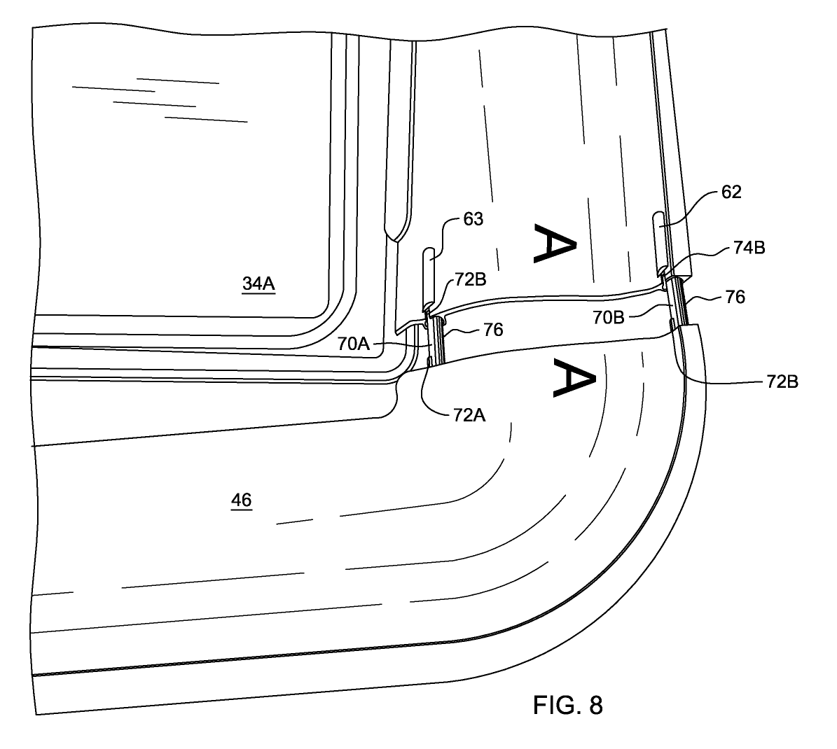

Referring to FIGS. 7, 8 and 9, and in particular, FIG. 7, upper chamber 67, associated with locking tab 58 and lower chamber 67A, associated with locking tab 60, are each designed to receive respective protrusions 70A and 70B, protruding from an end of front member 46, which curves so as to have the same orientation as and mate with right side member 44 (FIG. 8).

Referring also to FIG. 6B, each of protrusions 70A and 70B is formed of a first rectangular portion 71A and 71B, respectively, which extend in a vertical direction. Second rectangular portions 71C and 71D, extend perpendicularly from first rectangular portion 71A and 71B, respectively. Alignment fins 73A and 73B, protruding from second rectangular portion 71C and 71D, respectively, mate with corresponding opening 74A and 74B in right side member 44 to assist in maintaining alignment and in relieving stress that otherwise could be placed on protrusions 70A and 70B when front side member 46 is assembled to right side member 44.

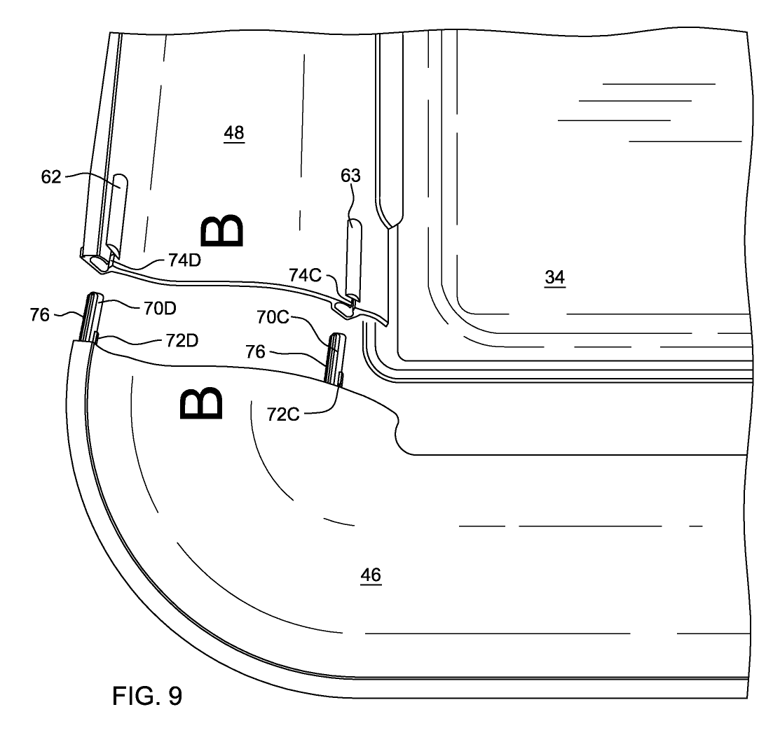

FIG. 9 shows an arrangement that is similar to that shown in FIG. 8, but illustrates the manner in which front side member 46 is releaseably assembled to left side member 48, when protrusions 70C and 70D are aligned with and received within corresponding chambers in left side member 48, containing corresponding locking tabs. Fins 72C and 72D are also received in corresponding openings 74C and 74D.

Outwardly facing surfaces of rectangular portions 71A and 71B of protrusions 70A and 70B respectively (and corresponding portions of protrusions 70C and 70D), may be formed with a series of groves 76 so as to interact with the portions of locking tabs 58 and 60 which extend into chambers 67 and 67A to lead to a more secure assembly of the parts of seed catcher 40 to each other.

The manner in which, and apparatus for, releaseably connecting rear member 42 to right side member 44 and left side member 48 may be identical to what has been described above with respect to front member 46.

When the seed catcher 40 is fully assembled to base 34, as shown in FIG. 3, the rear member 42 and the front member 46 curve around the corners of base 34 to mate at their curved ends with the right side member 44 and the left side member 48, to thus form a continuous barrier to seed shells and other waste material that is ejected from the birdcage 30 (FIG. 3). The wall and top structure 32 is secured to base 34 as described above. However, of great advantage to the owner of the birdcage 30 in accordance with the invention, is the fact that back member 42 and front member 46 may be disassembled from right side member 44 and left side member 48 by simply pulling the members apart, and then right side member 44 and left side member 48 may be dissembled from base 34, all without removing the wall and top structure 32 from base 34, thus allowing the bird to remain inside the birdcage 30, while the components of the seed catcher 40 are removed for ease of cleaning. Alternatively, if there are no interfering protrusions from birdcage 30, the entire seed catcher 40, including rear member 42, right side member 44, front side member 46 and left side member 48 may be removed as a unit, by simply pulling upward to remove the two pairs of protrusions 52 from base 34.

Thus, when in place upon base 34, a seed catcher in accordance with the invention efficiently and effectively returns seeds and other waste to the base of the birdcage 30, by way of openings between the wires at the bottom of wall and top structure 32.

It should be understood that the foregoing description is only illustrative of the invention. Various alternatives and modifications can be devised by those skilled in the art without departing from the invention. Accordingly, the present invention is intended to embrace all such alternatives, modifications and variances.

What is claimed is:

1. An animal cage comprising:
a generally closed base having an open top;
a grating structure upon the base forming a closed structure for contain an animal therein; and
a refuse catcher surrounding said grating structure and removeably fastened to said base so as to permit said refuse catcher to be removed from said base by being detached from said base and moved upward away from said base without removing said grating structure from said base.

2. The animal cage of claim 1, wherein said refuse catcher is formed of a plurality of mating parts, said parts being releasable attached to each other and to said base.

3. The animal cage of claim 2, wherein said plurality of parts may be released from each other so that a single part may released from said base.

4. The animal cage of claim 2, wherein:
said base is of generally polygonal shape;
said refuse catcher is formed of a plurality of parts, each part corresponding to a side of said base, and said base is configured with opening to accept a projection from at least a plurality of said parts so as to removeably connect said parts to said base.

5. The animal cage of claim 4, wherein two of said parts are sized and shaped to follow a corner of said base and to be in contact with two sides of said base, and two of said parts each contact only a single side of said base.

6. The animal cage of claim 2, wherein said base has a rim at its top, said rim defining a narrow ledge for receiving a bottom edge of said parts of said refuse catcher.

7. The animal cage of claim 2, wherein a plurality of said parts include a first projection for fitting into a first opening of an adjacent one of said parts.

8. The animal cage of claim 7, wherein said first projection is formed in the shape of a solid rectangle.

9. The animal cage of claim 8, wherein said first projection comprises a second solid rectangle perpendicular to said first solid rectangle, and said first opening is sized and shaped to receive said projection.

10. The animal age of claim 9, further comprising an alignment fin extending along at least a portion of said second solid rectangle, said alignment fin being received in a opening in said adjacent one of said parts.

11. The animal cage of claim 2, wherein a plurality of said parts include a second projection for fitting into a second opening of an adjacent one of said parts.

12. The animal cage of claim 10, wherein said second projection is formed generally in the shape of a solid rectangle.

13. The animal cage of claim 1, wherein said base is formed of a polymer.

14. The animal cage of claim 1, where said refuse catcher is formed of a polymer.

15. The animal cage of claim 14, wherein said polymer is of a type that is easily cleaned of debris.

16. The animal cage of claim 14, wherein said polymer is selected from the group comprising polystyrene and polypropylene.

17. The animal cage of claim 14, wherein said polymer is polystyrene.

18. The animal cage of claim 1, wherein said refuse catcher is shaped so as to curve away from said base.

19. The animal cage of claim 1, configured as a birdcage, wherein said refuse catcher is configured as a seed catcher.

20. The animal cage of claim 1, wherein said base is of a circular configuration.
